(19) United States
(12) Patent Application Publication
(10) Pub. No.: US 2012/0202044 A1
(43) Pub. Date: Aug. 9, 2012

(54) MICROPOROUS MEMBRANES, METHODS FOR MAKING SUCH MEMBRANES, AND THE USE OF SUCH MEMBRANES AS BATTERY SEPARATOR FILM

(76) Inventors: PATRICK BRANT, Seabrook, TX (US); Richard V. Gebben, Webster, NY (US); Koichi Kono, Nasushiobara-shi (JP)

(21) Appl. No.: 13/364,484

(22) Filed: Feb. 2, 2012

Related U.S. Application Data
(60) Provisional application No. 61/440,644, filed on Feb. 8, 2011.

(51) Int. Cl. B32B 5/18; C08L 23/04; B29C 55/02; C08F 10/02; B32B 3/26; B29C 47/00

(52) U.S. Cl. 428/315.5; 264/210.1; 521/149; 521/134

(57) ABSTRACT

The invention relates to microporous membranes having one or more layers comprising polymer and inorganic molecules. The invention also relates to methods for producing these membranes, and the use of these membranes as battery separator film.

### FIELD OF THE INVENTION

The invention relates to microporous membranes having one or more layers comprising polymer and inorganic molecules. The invention also relates to methods for producing these membranes, and the use of these membranes as battery separator film.

### BACKGROUND OF THE INVENTION

Microporous polymeric membranes have been used as battery separator film in primary and secondary batteries such as lithium ion primary and secondary batteries. For example, PCT Patent Application Publication No. WO 2008/016174A1 discloses a microporous polymeric membrane and the use of the membrane as a battery separator film. According to the disclosure, the membrane is produced by co-extruding a mixture of polymer and diluent, stretching the extrudate, and then removing the diluent.

Multilayer membranes are desirable because the layered structures allow improved control over the balance of membrane properties such as meltdown temperature, shutdown temperature, mechanical strength, porosity, permeability, etc.

Fillers can be used to improve membrane properties, such as heat resistance. For example, U.S. Patent Publication Nos. 2009/0155678 and 2009/0087728 disclose microporous membranes having at least one layer comprising a nanocomposite of inorganic nanoparticles, such as polyhedral oligomeric silesquioxane, dispersed in a polymer matrix. Although membrane heat resistance can be improved, using fillers can lead to a deterioration in other desirable membrane properties, particularly at increased filler concentration. For example, U.S. Pat. No. 5,336,573 discloses adding an inorganic filler to one or more layers of a microporous polymeric membrane which can lead to lower strength and flexibility. U.S. Patent Publication No. 2008/0193833 discloses that using fillers to improve membrane heat resistance can inhibit the ability to produce thin membranes with desirable permeability and mechanical strength. Other references attribute deterioration in membrane properties to filler agglomeration or inadequate dispersion of the filler in the membrane. For example, U.S. Patent Publication No. 2007/0116944 suggests that poor filler dispersion can interfere with the filler's ability to initiate pore formation during film stretching.

Microporous membranes comprising inorganic filler and having an overall balance of desirable properties are therefore desired.

### SUMMARY OF THE INVENTION

In an embodiment, the invention relates to a membrane having at least one layer, the layer comprising a first polymer including recurring units derived from at least one inorganic molecule, wherein the membrane is microporous and has a meltdown temperature≧155.0° C., a normalized air permeability≦30.0 seconds/100 cm³/μm, and a normalized pin puncture strength≧1.0×10² mN/μm.

In another embodiment, the invention relates to a method for producing a membrane, comprising:
(1) extruding a mixture of diluent and polymer, wherein the polymer includes recurring units derived from at least one inorganic molecule;
(2) stretching the extrudate; and
(3) removing at least a portion of the diluent from the stretched extrudate.

In yet another embodiment, the invention relates to a membrane comprising first and second polymers and having at least one layer, the first polymer comprising polyethylene having an amount of terminal unsaturation≧0.20 per 1.0×10⁵ carbon atoms; wherein (i) at least one of the first or second polymer includes recurring units derived from at least one inorganic molecule and (ii) the membrane has a shutdown temperature≦130.0° C., a normalized air permeability≦30.0 seconds/100 cm³/μm, and a meltdown temperature≧190.0° C.

In other embodiments, the invention relates to one or more of (a) a membrane comprising first and second polymers and having at least one layer, the first polymer comprising polyolefin having a Tm in the range of 115.0° C. to 130.0° C. and an Mw in the range of 5.0×10³ to 4.0×10⁵; wherein (i) at least one of the first or second polymer includes recurring units derived from silicon and oxygen and (ii) the membrane a normalized air permeability≦30.0 seconds/100 cm³ μm, a shutdown temperature≦130.0° C., and a meltdown temperature≧190.0° C.; (b) a membrane having at least one layer, the layer comprising at least one polymer which includes recurring units derived from silicon, wherein the membrane is microporous and has a meltdown temperature≧155.0° C., normalized air permeability≦30.0 seconds/100 cm³ μm and a normalized pin puncture strength≧1.0×10² mN/μm; or (c) a membrane having at least one layer, the layer comprising polymer and POSS, wherein (a) the membrane is microporous; (b) the membrane has a meltdown temperature≧155.0° C., a normalized air permeability≦30.0 seconds/100 cm³ μm and a normalized pin puncture strength≧1.0×10² mN/mm; and (c)≦2.0° C. of the difference between the membrane's meltdown temperature and 150.0° C. is derived from polymer species containing <1.0 wt % inorganic content based on the weight of the polymer species.

### DETAILED DESCRIPTION OF ILLUSTRATIVE EMBODIMENTS

It is observed that when inorganic particles, such as inorganic nanoparticles, are dispersed in a polymer matrix at a relatively high concentration, the tendency of the particles to agglomerate introduces an undesirable compositional inhomogeneity, which can lead to an undesirable deterioration in membrane properties such as meltdown temperature, permeability and pin puncture strength.

The invention is based in part on the discovery that microporous membranes comprising polymer which include recurring units derived from at least one inorganic molecule can overcome these difficulties. The inorganic molecules can comprise, e.g., atoms including oxygen and one or more of Si, Ge, Sn, and Pb; particularly one or more molecules including at least one organosilicon having a silicon:(oxygen+nitrogen) molar ratio of 0.3 to 3.5, particularly a molar ratio of from 0.5 to 1.5, wherein the silicon:(oxygen+nitrogen) molar ratio is based oxygen and nitrogen atoms bound to silicon. For the purpose of this description and appended claims, the term “which includes recurring units derived from at least one inorganic molecule” means that the recurring units are incorporated into the molecular structure of the polymer, as distinct from merely being blended with the polymer.

In particular embodiments, the organosilicon is selected from the group consisting of polysilsesquioxanes, polyhedral oligomeric silsesquioxanes (POSS), polyhedral oligomeric silicates (POS), and mixtures thereof. Some suitable polyhedral oligomeric silicates (POS) follow one or more of the following general formulas: 1) [RSiO_{1.5}]ₙ, 2) [RSiO_{1.5}]ₙ[RXSiO_{1.0}]ₘ, or 3) [RSiO_{1.5}]ₙ[RSiO_{1.0}]ₘ[M]ⱼ, wherein

n, is an integer ranging from 1 to 100;

m is an integer ranging from 1 to 100; and

j is an integer ranging from 1 to 100;

each R is independently a hydrogen atom, a C₁ to C₂₀ alkyl group, a C₁ to C₂₀ aryl group, a C₁ to C₂₀ hydroxyalkyl group, a C₁ to C₂₀ amine, a C₁ to C₂₀ imide, a nitride, a C₁ to C₂₀ carboxylic acid, a C₁ to C₂₀ ester, a C₁ to C₂₀ acrylate, a C₁ to C₂₀ epoxide, a C₁ to C₂₀ ketone, a C₁ to C₂₀ olefin group, a C₁ to C₂₀ ether-containing group, or a halide.

Polyhedral oligomeric silsesquioxane or polyhedral oligomeric silicates may also be described by Formula (I), (II), or (III):

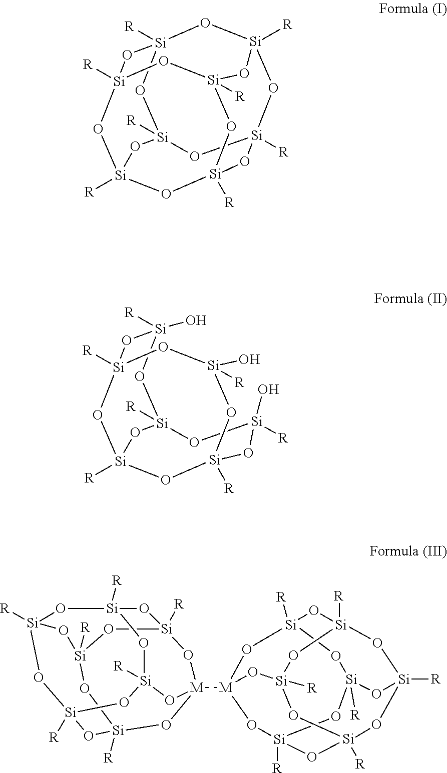

wherein each R is independently selected from a hydrogen atom; a halide; a substituted or unsubstituted, linear or branched C₁ to C₂₀ alkyl group; a substituted or unsubstituted, linear or branched C₁ to C₂₀ aryl group; a substituted or unsubstituted, linear or branched C₁ to C₂₀ amine, a substituted or unsubstituted, linear or branched C₁ to C₂₀ hydroxyalkyl; and wherein M is a metal atom, preferably aluminum or tin. In particular embodiments, each R is independently a methyl group, an ethyl group, a phenyl group, an isobutyl group, an isooctyl group, a cyclohexyl group, or a cyclopentyl group, more particularly each R is an isobutyl to group or an isooctyl group.

For example, in an embodiment, microporous membranes comprise polyolefin containing repeating units derived from POSS. Although the invention is not limited thereto, the invention is applicable to microporous membranes irrespective of whether the membrane is prepared by a wet process, dry process, or some combination thereof. Optionally, the membrane is a monolayer membrane, e.g., it contains one layer only.

It is observed that when a membrane comprises polymer which includes recurring units derived from at least one inorganic molecule, the membrane has improved meltdown temperature and strength characteristics, particularly at high inorganic content and elevated temperature, compared to microporous membranes comprising a polymer matrix with inorganic particles dispersed therein. While not wishing to be bound by any theory or model, it is believed that including recurring inorganic-derived units in the membrane's polymer leads to improved membrane properties as a result of the lower mobility and greater positional control of the membrane's inorganic component compared to membranes where the inorganic particles are dispersed in a polymer matrix. This increases the membrane designer's flexibility in selecting polymers to achieve a desirable membrane functionality.

For example, it can be desirable for membranes to contain one or more layers comprised of relatively low molecular weight polyolefin (e.g., having a weight average molecular weight (“Mw”) of < about 4.0×10⁵) or polyethylene containing a relatively large amount of terminal unsaturation (e.g., ≧0.20 per 1.0×10⁵ carbon atoms), e.g., when low membrane shutdown temperature is desired. It has been observed however, that including these polymers generally results in a membrane having lower strength, lower permeability, lower electrochemical stability, lower meltdown temperature, and higher heat shrinkage compared to membranes produced from higher Mw polyolefin or polyolefin having fewer terminal unsaturations. The magnitude of this problem can be reduced when the membrane comprises polymer including recurring units derived from at least one inorganic molecule such as POSS. Although it can be desirable to include the recurring inorganic-derived units in the low Mw or high terminal unsaturation polyolefin, this is not required, and the invention encompasses membranes where the recurring inorganic-derived units are included in other polymers in the membrane, such as in polyethylene having a terminal unsaturation amount <0.20 per 1.0×10⁵ carbon atoms, polyethylene having an Mw≧4.0×10⁵, polypropylene, polymethylpentene, or combinations thereof.

For the purpose of this description and the appended claims, the term “polymer” means a composition including a plurality of macromolecules, the macromolecules containing recurring units derived from one or more monomers. The macromolecules can have different size, molecular architecture, atomic content, etc. The term “polymer” includes macromolecules such as copolymer, terpolymer, etc. “Polyethylene” means polyolefin containing ≧50.0% (by number) recurring ethylene-derived units, preferably polyethylene homopolymer and/or polyethylene copolymer wherein at least 85% (by number) of the recurring units are ethylene units. “Polypropylene” means polyolefin containing >50.0% (by number) recurring propylene-derived units, preferably polypropylene homopolymer and/or polypropylene copolymer wherein at least 85% (by number) of the recurring units are propylene units. The term isotactic polypropylene means polypropylene having a meso pentad fraction ≧ about 50.0 mol. % mmmm pentads, preferably ≧96.0 mol. % mmmm pentads (based on the total number of moles of isotactic polypropylene).

A “microporous membrane” is a thin film having pores, where ≧90.0% (by volume) of the film's pore volume resides in pores having average diameters in the range of from 0.01 μm to 10.0 μm. With respect to membranes produced from extrudates, the machine direction (“MD”) is defined as the direction in which an extrudate is produced from a die. The transverse direction (“TD”) is defined as the direction perpendicular to both MD and the thickness direction of the extrudate. MD and TD can be referred to as planar directions of the membrane, where the term “planar” in this context means a direction lying substantially in the plane of the membrane when the membrane is flat.

### Membrane Composition

In an embodiment, the membrane is a microporous membrane comprising at least one layer, the layer comprising a polymer which includes recurring units derived from at least one inorganic molecule. For example, in one embodiment, the layer comprises a polymer mixture, wherein the mixture comprises (i) a first polymer which includes recurring units derived from at least one inorganic molecule and (ii) a second polymer such as polyolefin (or a mixture of polyolefins). While the membrane is described below in terms of at least one layer comprising (i) a polymer which includes recurring units derived from at least one inorganic molecule and (ii) a second polymer comprising polyethylene, the invention is not limited thereto, and this description is not meant to exclude other embodiments within the broader scope of the invention. The first and second polymers will now be described in more detail.

In an embodiment, the invention relates to a microporous membrane comprising at least one layer, the layer comprising a polymer which includes recurring units derived from at least one inorganic molecule. For example, the polymer mixture can comprise a first polymer, wherein the first polymer (which contains recurring units derived from POSS) has a melting point (“Tm”)≧160.0° C., an Mw≧5.0×10⁴, a molecular weight distribution (“MWD” defined as Mw divided by the number−average molecular weight)≦20.0. Optionally, the polymer mixture further comprises a second polymer. The second polymer can be, e.g., polyethylene having an Mw≧5.0×10⁴, an MWD≦20.0, and a Tm≧132.0° C. In an embodiment, the second polymer has both (i) a Tm≧160.0° C. and (ii) <1.0 wt % inorganic content based on the weight of the second polymer. Optionally, the amount of second polymer in the membrane is ≦1.0 wt %, e.g., in the range of 0.01 wt % to 1.0 wt % based on the weight of the membrane. Polyethylene melting point can be determined using the methods disclosed in PCT Patent Application Publication No. WO 2008/140835, for example.

The amount of the first polymer in the polymer mixture is optionally in the range of about 0.01 wt % to about 100.0 wt %, such as in the range of about 10.0 wt % to about 50.0 wt %, e.g., in the range of about 20.0 wt % to about 40.0 wt %, based on the weight of the polymer mixture. The amount of second polymer in the polymer mixture is optionally in the range of about 0.0 wt % to about 99.9 wt %, such as in the range of about 50.0 wt % to about 90.0 wt. %, e.g., in the range of about 60.0 wt % to about 80.0 wt %, based on the weight of the polymer mixture. When the second polymer is polyethylene, the polyethylene can comprise a polyethylene mixture (e.g., a dry mixture or reactor blend), such as (a) ≧45.0 wt %, e.g., in the range of 50.0 wt % to 95.0 wt %, of a first polyethylene having an Mw≦1.0×10⁶, an MWD≦20.0, and a Tm≧132.0° C. and (b) ≧5.0 wt %, e.g., in the range of 5.0 wt % to 50.0 wt %, of a second polyethylene having an Mw≧1.0×10⁶, an MWD≦20.0, and a Tm≧134.0° C., the weight percents being based on the weight of the polyethylene mixture. Optionally, the polymer mixture further comprises 1.0 wt % to 25.0 wt % polypropylene, based on the weight of the polymer mixture. The polypropylene, when used, comprises isotactic polypropylene having an Mw≧6.0×10⁵, an MWD≦20.0, a heat of fusion (“ΔHm”)≧90.0 J/g, e.g., and a Tm≧162.0° C. In an embodiment, the membrane has a meltdown temperature≧155.0° C., normalized air permeability≦20.0 seconds/100 cm³ μm and a normalized pin puncture strength≧2.0×10² mN/μm. Optionally, substantially all of the inorganic material in the membrane (e.g., ≧99.0 wt % based on the total weight of inorganic material in the membrane) is in the form of POSS included as recurring units in polymer species.

In an embodiment, the membrane contains ≦1.0 wt % (based on the weight of the membrane) of a polymer having both (i) a Tm≧160.0° C. and (ii) <1.0 wt % inorganic content (based on the weight of the polymer), such as polypropylene homopolymer or polymethylpentene homopolymer. Optionally, such a membrane has a meltdown temperature ≧160.0° C., such as ≧180.0° C. or ≧220.0° C.; and one or more of a TD heat shrinkage at 105° C. ≦5.0%, e.g., ≦2.5%, such as ≦10.0%; a TD heat shrinkage at 130° C. ≦20.0%; a TD heat shrinkage at 170° C. ≦40.0%; a thickness ≦30.0 μm, and a porosity in the range of 20% to 80%. For example, in an embodiment the membrane consists of (or consists essentially of) polymer (a) polymer wherein ≧99.0% (by number) of the polymer's recurring units are derived from POSS and at least one alpha-olefin (such as ethylene, propylene, or methylpentene) and (b) polyolefin homopolymer.

The embodiments of the preceding invention serve to amplify certain aspects of the invention, but the invention is not limited thereto, and this description of these embodiments is not meant to foreclose other embodiments within the broader scope of the invention. The microporous membrane comprises polymers, and these polymers will now be described in more detail.

### The First Polymer

In an embodiment, the first polymer includes recurring units derived from inorganic molecule. For example, the inorganic molecule can comprise (i) one or more elements from Group 16 of the Periodic Table of the Elements (Merck Index, 14th Edition, 2006), such as oxygen, and one or more of Si, Ge, Sn, and Pb. Optionally, the inorganic molecule comprises POSS and can optionally further comprise halogen, such as chlorine.

The first polymer can be produced by incorporating recurring units of open- and/or closed-cage nanostructure species into a thermoplastic polymer. Such polymers and methods for making such polymers are described in U.S. Pat. No. 6,933,345, which is incorporated by reference herein in its entirety. Closed- and open-cage inorganic nanostructure species, such as POSS, and methods for producing such species, are described in U.S. Pat. No. 5,942,638, which is also incorporated by reference herein in its entirety. For example, metal-catalyzed metathesis chemistry can be used to form both linear or network polyhedral silsesquioxane polymers directly from α-olefin-containing polyhedral oligomeric silsesquioxanes. Methods for grafting or reactively polymerizing POSS entities onto polymeric chains include, e.g., addition, insertion, and condensation polymerization using olefinic co-monomers, such as ethylene and/or propylene.

In an embodiment, mono-functional POSS-monomers are grafted onto thermoplastic polymers, such as polyolefin (e.g., polyethylene or polypropylene) as pendant side-chain groups and as chain terminators in the same manner as a traditional monofunctional organic monomer. In another embodiment, difunctional POSS-monomers are copolymerized (with ethylene and/or propylene comonomers) into the backbone of polymers in the same manner as a traditional Bifunctional organic monomer. In yet another embodiment, polyfunctional POSS species are copolymerized by methods similar to those used for difunctional POSS species, e.g., to impart a crosslinking adhesion-promoting, or thermosetting functionality to the first polymer.

In an embodiment, polymerization of POSS species and olefin comonomer is conducted under metallocene-catalyst polymerization conditions, using a catalytically effective amount of metallocene catalyst and, optionally, a co-catalyst such as methylalumoxane. A non-limiting description of such polymerization and co-polymerization methods is provided in Group IVA Polymers, Volume 4, Alaa S. Abd-El Aziz, John Wiley and Sons, 2005, which is incorporated by reference herein in its entirety. When the inorganic molecule is incorporated into the polymer as a pendent side-chain, isotactic tacticity is desirable.

In an embodiment, the first polymer comprises at least one of (i) polyethylene or polypropylene, each having pendent side chains derived from POSS, or (ii) a copolymer (random or block) of polyolefin (e.g., polyethylene or propylene) having POSS incorporated into the polymer backbone. The amount of POSS incorporated into the polymer in either case (i) or (ii) is ≧0.1 wt %, based on the weight of the first polymer, e.g., ≧1.0 wt %, such as ≦15.0 wt %. Optionally, the amount of POSS in the first polymer is in the range of about 0.1 wt % to about 50.0 wt %, e.g., in the range of about 0.5 wt % to about 20.0 wt %, or about 1.0 wt % to about 10.0 wt %, based on the weight of the first polymer.

Optionally, the first polymer has an Mw≧5.0×10⁴, such as ≧5.0×10⁵, for example in the range of from about 5.0×10⁵ to about 2.0×10⁶, such as in the range of about 0.90×10⁶ to about 3.0×10⁶. Optionally, the first polymer has a Tm≧160.0° C. Optionally, the first polymer has an MWD≦20.0, or ≦6.0, e.g., in the range of from about 1.5 to about 10.0, such as in the range of from about 2.0 to about 9.0 or in the range of from 2.5 to 8.0.

### The Second Polymer

In an embodiment, the second polymer comprises polyolefin, such as one or more of polyethylene, polypropylene, polymethylpentene, etc. The second polymer can be in the form of a mixture of polyolefin, such as a dry mixture or reactor blend. In an embodiment, the second polymer is a polyethylene mixture comprising first and second polyethylene homopolymers.

### PE1

In an embodiment, the first polyethylene (“PE1”) is, e.g., one having an Mw<1.0×10⁶, e.g., in the range of from about 1.0×10⁵ to about 0.90×10⁶, an MWD in the range of from about 2.0 to about 50.0, and a terminal unsaturation amount <0.20 per 1.0×10⁴ carbon atoms. Optionally, PE1 has an Mw in the range of from about 4.0×10⁵ to about 6.0×10⁵, and an MWD of from about 3.0 to about 10.0, and a Tm≧132.0. Optionally, PE1 has an amount of terminal unsaturation ≦0.14 per 1.0×10⁴ carbon atoms, or ≦0.12 per 1.0×10⁴ carbon atoms, e.g., in the range of 0.05 to 0.14 per 1.0×10⁴ carbon atoms (e.g., below the detection limit of the measurement).

### PE2

In an embodiment, the third polyethylene (“PE3”) is, e.g., one having an Mw≧1.0×10⁶, e.g., in the range of from about 1.0×10⁶ to about 5.0×10⁶; and an MWD≦20.0, e.g., ≦15.0, such as in the range of from about 1.2 to about 20.0; and a Tm≧134.0° C. A non-limiting example of PE3 is one having an Mw of from about 1.0×10⁶ to about 3.0×10⁶, for example about 2.0×10⁶, and an MWD≦20.0, e.g., in the range of from about 2.0 to about 20.0, preferably about 4.0 to about 15.0. PE2 can be, e.g., an ethylene homopolymer or an ethylene/α-olefin copolymer containing ≦5.0 mol. % of one or more comonomers, such as α-olefin, based on 100% by mole of the copolymer. The comonomer can be, for example, one or more of propylene, butene-1, pentene-1, hexene-1,4-methylpentene-1, octene-1, vinyl acetate, methyl methacrylate, or styrene. Such a polymer or copolymer can be produced using a Ziegler-Natta or a single-site catalyst, though this is not required. Such a PE can have a melting point ≧134.0° C.

### PE3

The second polymer can optionally comprise a third polyethylene, e.g., one having a Tm≦131.0° C. Such a polyethylene can be used, for example, when it is desired for the membrane to have a relatively low shutdown temperature. When used, PE3 is generally present in the polyethylene mixture in an amount ≦25.0 wt %, such as in the range of 1.0 wt % to 15.0 wt %, based on the weight of the polymer mixture.

In an embodiment, PE3 comprises an ethylene-based polyolefin homopolymer or copolymer having Tm≧110.0° C., e.g., in the range of from 115.0° C. to 130.0° C., and an Mw in the range of from 5.0×10³ to 4.0×10⁵. When the Tm is ≦115.0° C., it is more difficult to produce a thermally-stable membrane (one having low heat shrinkage, for example) without also reducing membrane permeability. Thermal treatment temperatures (e.g., heat setting temperatures)>110.0° C. are generally used to produce thermally-stable (low heat shrinkage) membranes, and membrane permeability decreases when the heat setting temperature is ≧ the polymer's Tm. In an embodiment, the first polyethylene has a Tm in the range of from 120.0° C. to 128.0° C., such as 120.0° C. to 126.0° C.

In an embodiment, the PE3 has an Mw in the range of from 8.0×10³ to 2.0×10⁵. In another embodiment, the first polyethylene has Mw in the range of from 1.0×10⁴ to 1.0×10⁵. Optionally, the first polyethylene has an MWD≦50.0, for example, in the range of from 1.5 to 20.0, from about 1.5 to about 5.0, or from about 1.8 to about 3.5.

In an embodiment, PE3 comprises a copolymer of ethylene and a comonomer such as α-olefin. The comonomer is generally present in a relatively small amount compared to the amount of ethylene. For example, the comonomer amount is generally less than 10% by mole based on 100% by mole of the copolymer, such as from 1.0% to 5.0% by mol. The comonomer can be, for example, one or more of propylene, butene-1, pentene-1, hexene-1,4-methylpentene-1, octene-1, vinyl acetate, methyl methacrylate, styrene, or other monomers. Such a polymer or copolymer can be produced using any suitable catalyst, including a single-site catalyst. For example, the PE3 can be produced according to the methods disclosed in U.S. Pat. No. 5,084,534 (such as the methods disclosed therein in examples 27 and 41), which is incorporated by reference herein in its entirety.

### Polypropylene

Optionally, the polymer mixture further comprises polypropylene. In an embodiment, the polypropylene (“PP”) is, e.g., one having an Mw≧6.0×10⁵, such as ≧7.5×10⁵, for example in the range of from about 0.80×10⁶ to about 2.0×10⁶, such as in the range of about 0.90×10⁶ to about 3.0×10⁶. Optionally, the PP has a Tm≧160.0° C. and a heat of fusion (“ΔHm”)≧90.0 J/g, e.g., ≧100.0 J/g, such as in the range of from 110 J/g to 120 J/g. Optionally, the PP has an MWD≦20.0, or ≦6.0, e.g., in the range of from about 1.5 to about 10.0, such as in the range of from about 2.0 to about 8.5 or in the range of from 2.5 to 6.0. Optionally, the PP is a copolymer (random or block) of propylene and ≦5.0 mol. % of a comonomer, the comonomer being, e.g., one or more α-olefins such as ethylene, butene-1, pentene-1, hexene-1,4-methylpentene-1, octene-1, vinyl acetate, methyl methacrylate, and styrene, etc.; or diolefins such as butadiene, 1,5-hexadiene, 1,7-octadiene, 1,9-decadiene, etc.

In an embodiment, the PP is isotactic polypropylene. Optionally, the PP has (a) a meso pentad fraction ≧ about 90.0 mol. % mmmm pentads, preferably ≧94.0 mol. % mmmm pentads; and (b) has an amount of stereo defects ≦ about 50.0 per 1.0×10⁴ carbon atoms, e.g., ≦ about 20 per 1.0×10⁴ carbon atoms, or ≦ about 10.0 per 1.0×10⁴ carbon atoms, such as ≦ about 5.0 per 1.0×10⁴ carbon atoms. Optionally, the PP has one or more of the following properties: (i) a Tm≧162.0° C.; (ii) an elongational viscosity ≧ about 5.0×10⁴ Pa sec at a temperature of 230° C. and a strain rate of 25 sec⁻¹; (iii) a Trouton's ratio ≧ about 15 when measured at a temperature of about 230° C. and a strain rate of 25 sec⁻¹; (iv) a Melt Flow Rate (“MFR”; ASTM D-1238-95 Condition L at 230° C. and 2.16 kg) ≦ about 0.1 dg/min, optionally ≦ about 0.01 dg/min (i.e., a value is low enough that the MFR is essentially not measurable); or (v) an amount extractable species (extractable by contacting the PP with boiling xylene) ≦0.5 wt %, e.g., ≦0.2 wt %, such as ≦0.1 wt % or less based on the weight of the PP.

In an embodiment, the PP is an isotactic PP having an Mw in the range of from about 0.8×10⁶ to about 3.0×10⁶, optionally 0.9×10⁶ to about 2.0×10⁶ and MWD≦8.5, e.g., in the range of from about 2.0 to about 8.5, optionally 2.0 to 6.0, and a ΔHm≧90.0 J/g. Generally, such a PP has a meso pentad fraction ≧94.0 mol. % mmmm pentads, an amount of stereo defects ≧ about 5.0 per 1.0×10⁴ carbon atoms, and a Tm≧162.0° C.

A non-limiting example of the PP, and methods for determining the PP's Tm, meso pentad fraction, tacticity, intrinsic viscosity, Trouton's ratio, stereo defects, and amount of extractable species are described in PCT Patent Application Publication. No. WO 2008/140835, which is incorporated by reference herein in its entirety.

The PP's ΔHm, is determined by the methods disclosed in PCT Patent Application Publication No. WO 2007/132942, which is incorporated by reference herein in its entirety. Tm can be determined from differential scanning calorimetric (DSC) data obtained using a Perkin Elmer Instrument, model Pyris 1 DSC. Samples weighing approximately 5.5-6.5 mg are sealed in aluminum sample pans. Starting at a temperature 30° C., Tm is measured by heating the sample to 230° C. at a rate of 10° C./minute, called first melt (no data recorded). The sample is kept at 230° C. for 10 minutes before a cooling-heating cycle is applied. The sample is then cooled from 230° C. to 25° C. at a rate of 10° C./minute, called “crystallization”, then kept at 25° C. for 10 minutes, and then heated to 230° C. at a rate of 10° C./minute, called “second melt”. The thermal events in both crystallization and second melt are recorded. The melting temperature (Tₘ) is the peak temperature of the second melting curve and the crystallization temperature (T_{c}) is the peak temperature of the crystallization peak.

### Other Species

Optionally, the polymer mixture further comprises inorganic materials (such as compositions containing silicon and/or aluminum atoms), and/or heat-resistant polymers such as those described in PCT Patent Application Publication Nos. WO 2007/132942 and WO 2008/016174 (both of which are incorporated by reference herein in their entirety). When used, the amount of such materials is generally ≦1.0 wt %, based on the weight of the polymer mixture. In an embodiment, these optional species are not used.

When the microporous membrane is produced by extrusion, the final microporous membrane generally comprises the materials used to produce the extrudate. A small amount of diluent or other species introduced during processing can also be present, generally in amounts less than 1 wt % based on the weight of the membrane. A small amount of polymer molecular weight degradation might occur during processing, but this is acceptable. In a form, molecular weight degradation during processing, if any, causes the value of MWD of the polymer in the membrane to differ from the MWD of the polymer used to produce the membrane (e.g., before extrusion) by no more than, e.g., about 10%, or no more than about 1%, or no more than about 0.1%.

### Mw and MWD Determination

Polymer Mw and MWD can be determined using a High Temperature Size Exclusion Chromatograph, or “SEC”, (GPC PL 220, Polymer Laboratories), equipped with a differential refractive index detector (DRI). The measurement is made in accordance with the procedure disclosed in “Macromolecules, Vol. 34, No. 19, pp. 6812-6820 (2001)”. Three PLgel Mixed-B columns (available from Polymer Laboratories) are used for the Mw and MWD determination. For PE, the nominal flow rate is 0.5 cm³/min; the nominal injection volume is 300 μL; and the transfer lines, columns, and the DRI detector are contained in an oven maintained at 145° C. For PP, the nominal flow rate is 1.0 cm³/min; the nominal injection volume is 300 μL; and the transfer lines, columns, and the DRI detector are contained in an oven maintained at 160° C. Similar methods can be used for the first polymer.

The GPC solvent used is filtered Aldrich reagent grade 1, 2, 4-Trichlorobenzene (TCB) containing approximately 1000 ppm of butylated hydroxy toluene (BHT). The TCB is degassed with an online degasser prior to introduction into the SEC. The same solvent is used as the SEC eluent. Polymer solutions are prepared by placing dry polymer in a glass container, adding the desired amount of the TCB solvent, and then heating the mixture at 160° C. with continuous agitation for about 2 hours. The concentration of polymer solution is 0.25 to 0.75 mg/ml. Sample solutions are filtered off-line before injecting to GPC with 2 μm filter using a model SP260 Sample Prep Station (available from Polymer Laboratories).

The separation efficiency of the column set is calibrated with a calibration curve generated using seventeen individual polystyrene standards ranging in Mp (“Mp” being defined as the peak in Mw) from about 580 to about 10,000,000. The polystyrene standards are obtained from Polymer Laboratories (Amherst, Mass.). A calibration curve (logMp vs. retention volume) is generated by recording the retention volume at the peak in the DRI signal for each PS standard and fitting this data set to a 2nd-order polynomial. Samples are analyzed using IGOR Pro, available from Wave Metrics, Inc.

### Membrane Production Method

In one or more embodiments, the microporous membranes can be produced by combining the first and second polymers (e.g., by dry blending or melt mixing) with diluent and optional constituents, such as inorganic fillers to form a mixture, and then extruding the mixture to form an extrudate. At least a portion of the diluent is removed from the extrudate to form the microporous membrane. For example, a blend of the first and second polymers can be combined with diluent such as liquid paraffin to form a mixture, with the mixture being extruded to form a monolayer membrane. Optionally, when the inorganic molecule incorporated into the first polymer is derived from POSS, the amount of POSS incorporated (e.g., as a pendent group or side chain) into the first polymer is such that the polymer blend comprises an amount of POSS of ≧1.0 wt %, based on the weight of the polymer blend, e.g., ≧10.0 wt %, such as ≧20.0 wt %. For example, the amount of POSS incorporated into the first polymer can be such that the amount of POSS in the polymer blend is in the range of 1.0 wt % to 60.0 wt %, e.g., in the range of 5.0 wt % to 50.0 wt %, such as 10.0 wt % to 40.0 wt %, based on the weight of the first polymer. Additional layers can be applied to the extrudate, if desired, e.g., to provide the finished membrane with a low shutdown functionality. In other words, monolayer extrudates or monolayer microporous membranes can be laminated or coextruded to form multilayered membranes.

The process for producing the membrane can further comprise optional steps for, e.g., removing at least a portion of any remaining volatile species from the membrane at any time after diluent removal, subjecting the membrane to a thermal treatment (such as heat setting or annealing) before or after diluent removal, stretching the extrudate in at least one planar direction before diluent removal, and/or stretching the membrane in at least one planar direction after diluent removal. An optional hot solvent treatment step, an optional heat setting step, an optional cross-linking step with ionizing radiation, and an optional hydrophilic treatment step, etc., as described in PCT Patent Application Publication No. WO 2008/016174 can be conducted if desired. Neither the number nor order of the optional steps is critical.

### Producing the Polymer-Diluent Mixture

In one or more embodiments, the first and second polymers (as described above) are combined to form a polymer mixture and the mixture is combined with diluent (which can be a mixture of diluents, e.g., a solvent mixture) to produce a polymer-diluent mixture. Mixing can be conducted, e.g., in an extruder such as a reaction extruder. Such extruders include, without limitation, twin-screw extruders, ring extruders, and planetary extruders. Practice of the invention is not limited to the type of reaction extruder employed. Optional species can be included in the polymer-diluent mixture, e.g., fillers, antioxidants, stabilizers, and/or heat-resistant polymers. The type and amounts of such optional species can be the same as described in PCT Patent Application Publication Nos. WO 2007/132942, WO 2008/016174, and WO 2008/140835, all of which are incorporated by reference herein in their entirety.

The diluent is generally compatible with the polymers used to produce the extrudate. For example, the diluent can be any species or combination of species capable of forming a single phase in conjunction with the polymer mixture at the extrusion temperature. Examples of the diluent include one or more of aliphatic or cyclic hydrocarbon such as nonane, decane, decalin and paraffin oil, and phthalic acid ester such as dibutyl phthalate and dioctyl phthalate. Paraffin oil with a kinetic viscosity of 20-200 cSt at 40° C. can be used, for example. The diluent can be the same as those described in U.S. Patent Publication Nos. 2008/0057388 and 2008/0057389, both of which are incorporated by reference in their entirety.

In an embodiment, the polymer mixture is mixed within an extruder operating at ≦400 rpm, in other embodiments ≦350 rpm, in other embodiments ≦300 rpm, in other embodiments ≦275 rpm, in other embodiments ≦250 rpm, and in other embodiments ≦225 rpm. In an embodiment, the polymer-diluent mixture during extrusion is exposed to a temperature in the range of 140° C. to 250° C., e.g., 210° C. to 240° C. In an embodiment, the amount of diluent used to produce the extrudate is in the range, e.g., of from about 20.0 wt % to about 99.0 wt % based on the weight of the polymer-diluent mixture, with the balance being polymer. For example, the amount of diluent can be in the range of about 60.0 wt % to about 80.0 wt %.

### Producing the Extrudate

In a form, the polymer-diluent mixture is conducted from an extruder through a die to produce the extrudate. The extrudate should have an appropriate thickness to produce, after the stretching steps, a final membrane having the desired thickness (generally ≧1.0 μm). For example, the extrudate can have a thickness in the range of about 0.1 mm to about 10.0 mm, or about 0.5 mm to 5 mm. Extrusion is generally conducted with the polymer-diluent mixture in the molten state. When a sheet-forming die is used, the die lip is generally heated to an elevated temperature, e.g., in the range of 140° C. to 250° C. Suitable process conditions for accomplishing the extrusion are disclosed in PCT Patent Application Publication Nos. WO 2007/132942 and WO 2008/016174.

If desired, the extrudate can be exposed to a temperature in the range of about 15° C. to about 25° C. to form a cooled extrudate. Cooling rate is not particularly critical. For example, the extrudate can be cooled at a cooling rate of at least about 30° C./minute until the temperature of the extrudate (the cooled temperature) is approximately equal to the extrudate's gelation temperature (or lower). Process conditions for cooling can be the same as those disclosed in PCT Patent Application Publication Nos. WO 2007/132942, WO 2008/016174, and WO 2008/140835, for example.

### Stretching the Extrudate (Upstream Stretching)

The extrudate or cooled extrudate can be stretched in at least one direction. The extrudate can be stretched by, for example, a tenter method, a roll method, an inflation method or a combination thereof, as described in PCT Patent Application Publication No. WO 2008/016174, for example. The stretching may be conducted monoaxially or biaxially, though the biaxial stretching is preferable. In the case of biaxial stretching, any of simultaneous biaxial stretching, sequential stretching or multi-stage stretching (for instance, a combination of the simultaneous biaxial stretching and the sequential stretching) can be used, though simultaneous biaxial stretching is preferable. When biaxial stretching is used, the amount of magnification need not be the same in each stretching direction. When the stretching results in orientation of the extrudate's polymers, it can be referred to as “upstream orientation”.

The stretching magnification can be, for example, 2 fold or more, preferably 3 to 30 fold in the case of monoaxial stretching. In the case of biaxial stretching, the stretching magnification can be, for example, 3 fold or more in any direction, namely 9 fold or more, such as 16 fold or more, e.g., 25 fold or more, in area magnification. An example for this stretching step would include stretching from about 9 fold to about 49 fold in area magnification. Again, the amount of stretch in either direction need not be the same. The magnification factor operates multiplicatively on film size. For example, a film having an initial width (TD) of 2.0 cm that is stretched in TD to a magnification factor of 4 fold will have a final width of 8.0 cm.

The stretching can be conducted while exposing the extrudate to a temperature (the upstream stretching temperature) in the range of from about the Tcd temperature to Tm, where Ted and Tm are defined as the crystal dispersion temperature and melting point of the PE having the lowest melting point among the polyethylenes used to produce the extrudate (generally the PE such as PE1 or PE3). The crystal dispersion temperature is determined by measuring the temperature characteristics of dynamic viscoelasticity according to ASTM D 4065. In an embodiment where Tcd is in the range of about 90° C. to about 100° C., the stretching temperature can be from about 90° C. to 125° C.; e.g., from about 100° C. to 125° C., such as from 105° C. to 125° C.

When the sample (e.g., the extrudate, dried extrudate, membrane, etc.) is exposed to an elevated temperature, this exposure can be accomplished by heating air and then conveying the heated air into proximity with the sample. The temperature of the heated air, which is generally controlled at a set point equal to the desired temperature, is then conducted toward the sample through a plenum, for example. Other methods for exposing the sample to an elevated temperature, including conventional methods such as exposing the sample to a heated surface, infra-red heating in an oven, etc., can be used with or instead of heated air.

### Diluent Removal

In an embodiment, at least a portion of the diluent is removed (or displaced) from the stretched extrudate to form a dried membrane. A displacing (or “washing”) solvent can be used to remove (wash away, or displace) the diluent, as described in PCT Patent Application Publication No. WO 2008/016174, for example.

In an embodiment, at least a portion of any remaining volatile species (e.g., washing solvent) is removed from the dried membrane after diluent removal. Any method capable of removing the washing solvent can be used, including conventional methods such as heat-drying, wind-drying (moving air), etc. Process conditions for removing volatile species, such as washing solvent, can be the same as those disclosed in PCT Patent Application Publication No. WO 2008/016174, for example.

### Stretching the Membrane (Downstream Stretching)

The dried membrane can be stretched (also called “dry stretching” since at least a portion of the diluent has been removed or displaced) in at least TD. Before dry stretching, the dried membrane has an initial size in MD (a first dry length) and an initial size in TD (a first dry width). As used herein, the term “first dry width” refers to the size of the dried membrane in TD prior to the start of dry orientation. The term “first dry length” refers to the size of the dried membrane in MD prior to the start of dry orientation. Tenter stretching equipment of the kind described in WO 2008/016174 can be used, for example.

The dried membrane can be stretched in MD from the first dry length to a second dry length that is larger than the first dry length by a magnification factor (the “MD dry stretching magnification factor”) in the range of from about 1.1 to about 1.6, e.g., in the range of 1.1 to 1.5. When TD dry stretching is used, the dried membrane can be stretched in TD from the first dry width to a second dry width that is larger than the first dry width by a magnification factor (the “TD dry stretching magnification factor”). Optionally, the TD dry stretching magnification factor is ≧ the MD dry stretching magnification factor. The TD dry stretching magnification factor can be in the range of from about 1.1 to about 1.6. The dry stretching (also called re-stretching since the diluent-containing extrudate has already been stretched) can be sequential or simultaneous in MD and TD. Since TD heat shrinkage generally has a greater effect on battery properties than does MD heat shrinkage, the amount of TD magnification generally does not exceed the amount of MD magnification. When biaxial dry stretching is used, the dry stretching can be simultaneous in MD and TD or sequential. When the dry stretching is sequential, generally MD stretching is conducted first, followed by TD stretching.

The dry stretching can be conducted while exposing the dried membrane to a temperature (the downstream stretching temperature) ≧Tm, e.g., in the range of from about Tcd-30° C. to Tm. In a form, the stretching temperature is conducted with the membrane exposed to a temperature in the range of from about 70° C. to about 135° C., for example from about 120° C. to about 132° C., such as from about 128° C. to about 132° C.

In a form, the MD stretching magnification is in the range of from about 1.0 to about 1.5, such as 1.2 to 1.4; the TD dry stretching magnification is ≦1.6, e.g. in the range of from about 1.1 to about 1.55, such as 1.15 to 1.5, or 1.2 to 1.4; the MD dry stretching is conducted before the TD dry stretching, and the dry stretching is conducted while the membrane is exposed to a temperature in the range of about 80° C. to about 132° C., e.g., in the range of about 122° C. to about 130° C. When the downstream stretching results in orientation of the membrane's polymer, it can be called “downstream orientation”.

The stretching rate is preferably 3%/second or more in the stretching direction (MD or TD), and the rate can be independently selected for MD and TD stretching. The stretching rate is preferably 5%/second or more, more preferably 10%/second or more, e.g., in the range of 5%/second to 25%/second. Though not particularly critical, the upper limit of the stretching rate is preferably 50%/second to prevent rupture of the membrane.

### Controlled Reduction of the Membrane's Width

Following the dry stretching, the dried membrane can be subjected to a controlled reduction in width from the second dry width to a third dry width, the third dry width being in the range of from the first dry width to about 1.1 times larger than the first dry width. The width reduction is generally conducted while the membrane is exposed to a temperature≧Tcd −30° C., but no greater than Tm. For example, during width reduction the membrane can be exposed to a temperature in the range of from about 70° C. to about 135° C., such as from about 122° C. to about 132° C., e.g., from about 125° C. to about 130° C. The temperature can be the same as the downstream orientation temperature. In a form, the decreasing of the membrane's width is conducted while the membrane is exposed to a temperature that is lower than Tm. In a form, the third dry width is in the range of from 1.0 times larger than the first dry width to about 1.4 times larger than the first dry width.

It is believed that exposing the membrane to a temperature during the controlled width reduction that is ≧ the temperature to which the membrane was exposed during the TD stretching leads to greater resistance to heat shrinkage in the finished membrane.

### Heat Set

Optionally, the membrane is thermally treated (heat-set) at least once following diluent removal, e.g., after dry stretching, the controlled width reduction, or both. It is believed that heat-setting stabilizes crystals and makes uniform lamellas in the membrane. In a form, the heat setting is conducted while exposing the membrane to a temperature in the range Tcd to Tm, e.g., a temperature in the range of from about 100° C. to about 135° C., such as from about 120° C. to about 132° C., or from about 122° C. to about 130° C. The heat set temperature can be the same as the downstream orientation temperature. Generally, the heat setting is conducted for a time sufficient to form uniform lamellas in the membrane, e.g., a time ≧1000 seconds, e.g., in the range of 1 to 600 seconds. In a form, the heat setting is operated under conventional heat-set “thermal fixation” conditions. The term “thermal fixation” refers to heat-setting carried out while maintaining the length and width of the membrane substantially constant, e.g., by holding the membrane's perimeter with tenter clips during the heat setting.

Optionally, an annealing treatment can be conducted after the heat-set step. The annealing is a heat treatment with no load applied to the membrane, and can be conducted by using, e.g., a heating chamber with a belt conveyer or an air-floating-type heating chamber. The annealing may also be conducted continuously after the heat-setting with the tenter slackened. During annealing, the membrane can be exposed to a temperature in the range of Tm or lower, e.g., in the range from about 60° C. to about Tm −5° C. Annealing is believed to provide the microporous membrane with improved permeability and strength.

Optional heated roller, hot solvent, crosslinking, hydrophilizing, and coating treatments can be conducted, if desired, e.g., as described in PCT Patent Application Publication No. WO 2008/016174.

### Structure and Properties of Membrane

The membrane is microporous membrane that is permeable to liquid (aqueous and non-aqueous) at atmospheric pressure. Thus, the membrane can be used as a battery separator, filtration membrane, etc. The membrane is particularly useful as battery separator film (“BSF”) for a secondary battery, such as a nickel-hydrogen battery, nickel-cadmium battery, nickel-zinc battery, silver-zinc battery, lithium-ion battery, lithium-ion polymer battery, etc. In an embodiment, the invention relates to lithium-ion secondary batteries containing BSF comprising the thermoplastic film. Such batteries are described in PCT Patent Application Publication No. WO 2008/016174, which is incorporated herein by reference in its entirety. Optionally, the membrane can have one or more of the following properties.

### Thickness

In an embodiment, the thickness of the final membrane is ≧1.0 μm, e.g., in the range of about 1.0 μm to about 1.0×10² μm. For example, a monolayer membrane can have a thickness in the range of about 1.0 μm to about 30.0 μm, and a multilayer membrane can have a thickness in the range of 7.0 μm to 30.0 μm, but these values are merely representative. The membrane's thickness can be measured, e.g., by a contact thickness meter at 1 cm longitudinal intervals over the width of 10 cm, and then averaged to yield the membrane thickness. Thickness meters such as a Model RC-1 Rotary Caliper, available from Maysun, Inc., 746-3 Gokanjima, Fuji City, Shizuoka, Japan 416-0946 or a “Litematic” available from Mitsutoyo Corporation, are suitable. Non-contact thickness measurement methods are also suitable, e.g., optical thickness measurement methods. In an embodiment, the membrane has a thickness ≦30.0 μm.

### Porosity ≧20.0%

The membrane's porosity is measured conventionally by comparing the membrane's actual weight to the weight of an equivalent non-porous membrane of 100% polymer (equivalent in the sense of having the same polymer composition, length, width, and thickness). Porosity is then determined using the formula: Porosity %=100×(w2−w1)/w2, where “w1” is the actual weight of the membrane, and “w2” is the weight of an equivalent non-porous membrane (of the same polymers) having the same size and thickness. In a form, the membrane's porosity is in the range of 20.0% to 80.0%, e.g., in the range of 25.0% to 85.0%.

Normalized Air Permeability≦50.0 Seconds/100 cm³/μm

In an embodiment, the membrane has a normalized air permeability≦50.0 seconds/100 cm³ μm (as measured according to JIS P8117), such as ≦40.0 seconds/100 cm³ μm, e.g., ≦30.0 seconds/100 cm³ μm. Optionally, the membrane has a normalized air permeability in the range of 10.0 seconds/100 cm³ μm to 30.0 seconds/100 cm³ μm. Since the air permeability value is normalized to the value for an equivalent membrane having a film thickness of 1.0 μm, the membrane's air permeability value is expressed in units of “seconds/100 cm³ μm”. Optionally, the membrane's normalized air permeability is in the range of from about 1.0 seconds/100 cm³ μm to about 25 seconds/100 cm³ μm. Normalized air permeability is measured according to JIS P8117, and the results are normalized to the permeability value of an equivalent membrane having a thickness of 1.0 μm using the equation A=1.0 μm*(X)/T₁, where X is the measured air permeability of a membrane having an actual thickness T₁ and A is the normalized air permeability of an equivalent membrane having a thickness of 1.0 μm.

Normalized Pin Puncture Strength≧1.0×10² mN/Seconds/100 cm³/μm

The membrane's pin puncture strength is expressed as the pin puncture strength of an equivalent membrane having a thickness of 1.0 μm and a porosity of 50% [mN/1.0 μm]. Pin puncture strength is defined as the maximum load measured at ambient temperature when in the membrane having a thickness of T₁ is pricked with a needle of 1 mm in diameter with a spherical end surface (radius R of curvature: 0.5 mm) at a speed of 2 mm/second. The pin puncture strength (“S”) is normalized to the pin puncture strength value of an equivalent membrane having a thickness of 1.0 μm and a porosity of 50% using the equation S₂=[50%*20 μm*(S₁)]/[T₁*(100%−P)], where S₁ is the measured pin puncture strength, S₂ is the normalized pin puncture strength, P is the membrane's measured porosity, and T₁ is the average thickness of the membrane. Optionally, the membrane's normalized pin puncture strength is ≧1.5×10² mN/μm, e.g., ≧2.0×10² mN/μm, such as in the range of 1.0×10² mN/μm to 2.5×10² mN/μm.

### Shutdown Temperature≦140.0° C.

The microporous membrane's shutdown temperature is measured by the method disclosed in PCT Patent Application Publication No. WO 2007/052663, which is incorporated by reference herein in its entirety. According to this method, the microporous membrane is exposed to an increasing temperature (5° C./minute beginning at 30° C.) while measuring the membrane's air permeability. The microporous membrane's shutdown temperature is defined as the temperature at which the microporous membrane's air permeability (Gurley Value) first exceeds 1.0×10⁵ seconds/100 cm³. For the purpose of measuring membrane meltdown temperature and shutdown temperature, air permeability can be measured according to JIS P8117 using, e.g., an air permeability meter (EGO-1T available from Asahi Seiko Co., Ltd.). In an embodiment, the shutdown temperature is ≦140.0° C. or ≦130.0° C., e.g., in the range of 128.0° C. to 133.0° C.

### Meltdown Temperature (as Measured by Membrane Rupture)≧155.0° C.

In an embodiment, the microporous membrane has a meltdown temperature≧160.0° C., such as ≧190.0° C., e.g., ≧200.0° C. Optionally, the membrane has a meltdown temperature in the range of about 190.0° C. to about 220.0° C. Meltdown temperature can be measured as follows. A sample of the microporous membrane measuring 5 cm×5 cm is fastened along its perimeter by sandwiching the sample between metallic blocks each having a circular opening of 12 mm in diameter. The blocks are then positioned so the plane of the membrane is horizontal. A tungsten carbide ball of 10 mm in diameter is placed on the microporous membrane in the circular opening of the upper block. Starting at 30° C., the membrane is then exposed to an increasing temperature at rate of 5° C./minute. The temperature at which the microporous membrane is ruptured by the ball is defined as the membrane's meltdown temperature.

### 105° C. TD Heat Shrinkage ≦5.0%

In an embodiment, the membrane has a TD heat shrinkage at 105.0° C. ≦5.0%, such as ≦0.5%, e.g., in the range of from about 0.01% to about 0.5%. Optionally, the membrane has an MD heat shrinkage at 105.0° C.≦2.5%, e.g., in the range of about 0.5% to about 2.0%.

The membrane's heat shrinkage in orthogonal planar directions (e.g., MD or TD) at 105.0° C. (the “105.0° C. heat shrinkage”) is measured as follows: (i) measure the size of a test piece of microporous membrane at 23.0° C. in both MD and TD; (ii) expose the test piece to a temperature of 105.0° C. for 8 hours with no applied load; and then (iii) measure the size of the membrane in both MD and TD. The heat (or “thermal”) shrinkage in either the MD or TD can be obtained by dividing the result of measurement (i) by the result of measurement and (ii) expressing the resulting quotient as a percent.

### 130° C. TD Heat Shrinkage and 170° C. TD Heat Shrinkage

In an embodiment, the membrane has a TD heat shrinkage at 130° C. ≦20.0%, such as ≦10.0%, for example in the range of from about 1.0% to about 7.5%. In an embodiment, the membrane has a TD heat shrinkage at 170° C. ≦40.0%, such as ≦30.0%, e.g., from about 15.0% to about 40.0%.

The measurement of 130° C. and 170° C. heat shrinkage is slightly different from the measurement of heat shrinkage at 105° C., reflecting the fact that the edges of the membrane parallel to the transverse direction are generally fixed within the battery, with a limited degree of freedom allowed for expansion or contraction (shrinkage) in TD, particularly near the center of the edges parallel to MD. Accordingly, a square sample of microporous film measuring 50 mm along TD and 50 mm along MD is mounted in a frame and exposed to a temperature of 23.0° C., with the edges parallel to TD fixed to the frame (e.g., by tape) leaving a clear aperture of 35 mm in MD and 50 mm in TD. The frame with sample attached is then exposed to a temperature of 130° C. or 170° C. for thirty minutes, and then cooled. TD heat shrinkage generally causes the edges of the film parallel to MD to bow slightly inward (toward the center of the frame's aperture). The shrinkage in TD (expressed as a percent) is equal to the length of the sample in TD before heating divided by the narrowest length (within the frame) of the sample in TD after heating times 100 percent.

This invention will be described in more detail with reference to Examples below without intention of restricting the scope of this invention.

### Example 1

In a simulation, a polymer-diluent mixture is prepared by combining diluent and a blend of a 82.0 wt % of a first polymer and 18.0 wt % of PE2, based on the weight of the blend. The first polymer contains 36.6 wt % of recurring pendant groups derived from vinyl

POSS and 63.4 wt % of recurring units derived from ethylene, the weight percents being based on the weight of the first polymer. The first polymer has an Mw of about 5×10⁵ and an MWD of about 5. The PE2 has an Mw of 1.9×10⁶, and MWD of 5.09, and a Tm of 136° C. The first polymer is produced from vinyl POSS and ethylene using a metallocene catalyst, under polymerization conditions described in Group IVA Polymers, Volume 4, Alaa S. Abd-El Aziz, John Wiley and Sons, 2005.

Next, 25.0 wt % of the polymer blend is charged into a strong-blending double-screw extruder having an inner diameter of 58 mm and L/D of 42, and 75.0 wt % liquid paraffin (50 cst at 40° C.) is supplied to the double-screw extruder via a side feeder. Mixing is conducted at 220° C. and 200 rpm to produce the polymer-diluent mixture, the weight percents being based on the weight of the polymer-diluent mixture.

### Membrane Production

The polymer-diluent mixture is conducted from the extruder to a sheet-forming die, to form an extrudate (in the form of a sheet). The die temperature is 210° C. The extrudate is cooled by exposing it to a temperature of 20° C. The cooled extrudate is simultaneously biaxially stretched (upstream stretching) at 115° C. to a magnification of 5 fold in both MD and TD. The stretched three-layer gel-like sheet is fixed to an aluminum frame of 20 cm×20 cm, immersed in a bath of methylene chloride controlled at 25° C. to remove liquid paraffin with vibration of 100 rpm for 3 minutes, and dried by air flow at room temperature. While holding the size of the membrane substantially constant, the membrane is then heat-set at 125° C. for 10 minutes to produce the final microporous membrane. Selected starting materials, process conditions, and membrane properties are set out in the table.

The polymers used to produce the membrane, selected process conditions, and selected membrane properties are set out in the table.

### Example 2

Example 1 is repeated except (i) the blend comprises 82.0 wt % of polyethylene homopolymer having an Mw of about 5.0×10⁵ and an MWD of about 5 (“PE1”) and 18.0 wt % of the PE2 and (ii) the membrane is produced and the results are measured, i.e., not simulated. PE1 does not contain recurring units derived from inorganic molecules. The microporous membrane has a thickness of 25.8 μm.

### Example 3

Example 2 is repeated except the blend comprises: (a) 3.0 wt % of octoisobutyl POSS (available from Hybrid Plastics, Inc. 55 W. L. Runnels Industrial Drive, Hattiesburg, Miss. 39401); (b) 79.6 wt % of the PE1; and (c) 17.4 wt % of the PE2. The microporous membrane has a thickness of 24.2 μm.

### Examples 4-6

Example 3 is repeated, except the blend composition is as set out in the following table.

| | | Ex. 1 | Ex. 2 | Ex. 3 | Ex. 4 | Ex. 5 | Ex. 6 |
|---|---|---|---|---|---|---|---|
| First Polymer | Content (wt %) | 82.0 | — | — | — | — | — |
| POSS | Content (wt %) | | — | 3.0 | 10.0 | 30.0 | 90.0 |
| Second | Grade | PE2 | PE2 | PE2 | PE2 | PE2 | PE2 |
| Polymer | Content (wt %) | 18.0 | 18.0 | 17.4 | 16.2 | 12.6 | 10.0 |
| | | PE1 | PE1 | PE1 | PE1 | PE1 | PE1 |
| | | — | 82.0 | 79.6 | 73.8 | 57.4 | — |

| | | | | | | |
|---|---|---|---|---|---|---|
| Processing Condition | | | | | | |
| Polymer content (wt %) polymer-diluent mixture | 25 | 25 | 25 | 25 | 25 | 40 |
| Extrusion | | | | | | |
| Extrusion Temperature (° C.) | 220 | 220 | 220 | 220 | 220 | 220 |
| Stretching | | | | | | |
| Temperature (° C.) | 115 | 115 | 115 | 115 | 115 | 115 |
| Magnification (MD × TD) | 5 × 5 | 5 × 5 | 5 × 5 | 5 × 5 | 5 × 5 | 5 × 5 |
| Heat Set (° C.) | 125 | 125 | 125 | 125 | 125 | 125 |
| Properties | | | | | | |
| Average Thickness (μm) | 20.0 | 25.8 | 24.2 | 18.7 | 12.0 | 11.0 |
| Porosity (%) | ≧30 | ≧30 | ≧30 | ≧30 | ≧30 | ≧30 |
| Normalized Air Permeability (sec/100 cm³/μm) | ≦20.0 | 10.0 | 9.1 | 13.2 | 26.1 | 2963 |
| Puncture Strength (mN/μm) | ≧125.0 | 98.6 | 101.4 | 130.5 | 97.2 | 283.7 |
| 105° C. TD Heat Shrinkage (%) | ≦5.0 | 2.8 | 2.1 | 1.9 | 2.7 | 1.5 |
| Meltdown Temperature (° C.) | ≧155.0 | 150.0 | 150.3 | 148.9 | 148.3 | 152 |
| Shutdown Temperature (° C.) | 130.0 | 130.0 | 131.7 | 132.6 | 130.0 | 128.6 |

As shown in the table, the membrane of Example 1 has a higher meltdown temperature and strength than that of Example 2 (which does not contain POSS). Although the membranes of Examples 3-6 contain POSS, the POSS is not present in the form of recurring units in a polymer. This undesirably leads to lower meltdown temperature and higher shutdown temperature (Examples 3-5) or very low permeability (Example 6).

1. A membrane having at least one layer, the layer comprising a first polymer including recurring units derived from at least one inorganic molecule, wherein the membrane is microporous and has a meltdown temperature≧155.0° C., a normalized air permeability≦30.0 seconds/100 cm³/μm, and a normalized pin puncture strength≧1.0×10² mN/μm.

2. The membrane of claim 1, wherein the recurring units are pendant groups derived from at least one organosilicon having silicon:(oxygen+nitrogen) molar ratio of 0.3 to 3.5, wherein the silicon:(oxygen+nitrogen) molar ratio is based oxygen and nitrogen atoms bound to silicon.

3. The membrane of claim 1, wherein the first polymer is polyolefin.

4. The membrane of claim 2, wherein the organosilicon is POSS.

5. The membrane claim 4, wherein the first polymer is polyethylene having an Mw<1.0×10⁶.

6. The membrane of claim 1, further comprising a second polymer having both (i) a Tm≧160.0° C. and (ii) <1.0 wt % inorganic content based on the weight of the second polymer, wherein the second polymer is present in the membrane in an amount in the range of 0.01 wt % to 1.0 wt % based on the weight of the membrane.

7. The membrane of claim 1, wherein the membrane further comprises a third polymer, the third polymer being polyolefin having an Mw≧1.0×10⁶.

8. The membrane of claim 7, wherein the third polymer is polyethylene.

9. The membrane of claim 1, further comprising a second layer, wherein the second layer comprises polymer.

10. (canceled)

11. A method for producing a membrane, comprising:
(1) extruding a maxture of diluent and polymer, wherein the polymer includes recurring units derived from at least one inorganic molecule;
(2) stretching and extrudate; and
(3) removing at least a portion of the diluent from the stretched extrudate.

12. The method of claim 11, wherein the recurring units are derived from at least one inorganic molecule including one or more of Si, Ge, Sn, and Pb.

13. The method of claim 11, wherein the inorganic molecule comprises at least one organosilicon having a silicon:(oxygen+nitrogen) molar ratio of 0.3 to 3.5, wherein the silicon: (oxygen+nitrogen) molar ratio is based on oxygen and nitrogen atoms bound to silicon.

14. The method of claim 11, wherein the inorganic molecule is POSS.

15. The method of claim 11, wherein the polymer comprises at least one of (i) polyethylene or polypropylene having pendent side chains derived from POSS or (ii) a copolymer (random or block) of polyoefin (e.g., polyethylene or propylene) having POSS incorporated into the polymer backbone.

16. The method of claim 11, wherein the polymer has an Mw≧5.0×10⁴ and a Tm≧160.0° C.

17. The method of claim 11, wherein the recurring units are incorporated into the polymer in an amount ≧0.1 wt %, based on the weight of the polymer.

18. The method of claim 11, wherein the mixture further comprises polyethylene or polypropylene homopolymer.

19. The method of claim 11, further comprising cooling the extrudate before step (2).

20. The membrane product of claim 11.

21. A membrane comprising first and second polymers and having at least one layer, the first polymer comprising polyethylene having an amount of terminal unsaturation ≧0.20 per 1.0×10⁵ carbon atoms, wherein (i) at least one of the first or second polymer includes recurring units derived from at least one inorganic molecule and (ii) the membrane has a shutdown temperature≦130.0° C., a normalized air permeability≦30.0 second/100 cm³/μm, and a meltdown temperature≧190.0° C.

22-25. (canceled)
